(19) United States
(12) Patent Application Publication
(10) Pub. No.: US 2013/0105279 A1
(43) Pub. Date: May 2, 2013

(54) SYSTEM AND METHOD FOR INDEPENDENTLY ROTATING CARRIERS

(71) Applicant: Hernando RAMIREZ, Palm Harbor, FL (US)

(72) Inventor: Hernando RAMIREZ, Palm Harbor, FL (US)

(21) Appl. No.: 13/655,023

(22) Filed: Oct. 18, 2012

Related U.S. Application Data
(60) Provisional application No. 61/553,571, filed on Oct. 31, 2011.

(51) Int. Cl. B65G 29/00

(52) U.S. Cl. 198/469.1

(57) ABSTRACT

A rotary indexing machine such as for use in the food preparation industry is configured with reduced velocity index to provide carriers which can be rotated on their mounting base independently at a reduced velocity separate from a main shaft rotation. The carriers may have the ability to rotate in satellite fashion and the rotation may be controlled by a combination of a cam follower fixed to each carrier and a cam plate fixed to the non-rotating machine base. The rotary index machine with reduced velocity index may assist in preventing content spillage while also increasing overall throughput of the overall container processing.

### CROSS-REFERENCE TO RELATED APPLICATIONS

This application claims benefit and priority to U.S. Provisional Application No. 61/553,571 filed Oct. 31, 2011, the disclosure of which is incorporated by reference herein in its entirety.

### BACKGROUND

1.0 Field of the Invention

This disclosure is generally rotating carriers for preparation of sealed containers for various products including food products and, more particularly, to a system and method directed to independently rotating carriers for preparation of sealed containers for various products including food products.

2.0 Related Art

Generally available rotating carriers for preparation of sealed containers for various products may include rotary indexing machines where a set of carriers is fixed to a central rotating shaft (indexing table). The central shaft may be driven clockwise or counterclockwise in indexing or continuous motion fashion. The set of carriers is fixed to a central shaft and therefore rotates with the shaft. Rotary machines may be used throughout various industries for different tasks. A product may be nested or held in the carriers and is being transferred from one position to the next through a process for preparing and sealing products. The carriers are “carrying” the products in a circular fashion. An illustrative example may be a rotary filling and sealing machine widely used in the food industry.

However, current rotating carriers have limitations that do not permit relative motion differentials, at least temporarily, such as from position to another position to permit a reduction in speed for at least a portion of the distances between positions. Relative motion changes can be useful, for example, to protect product from spilling for a portion of the filling/sealing process. A solution to provide differences in speed such as relative rotational speed from position to position during a filling/sealing process would permit increased production capacity and/or less spillage.

### SUMMARY OF THE INVENTION

The principles of the invention described herein improve on capabilities over the current available art and provides for, inter alia, relative speed changes and/or orientation of carriers from a first position to second position for rotary indexing machines. In one aspect, a rotary machine with reduced velocity index, configured according to principles of the invention is provided. The rotary system may provide carriers which can be rotated on their mounting base independently from the main shaft rotation. The carriers have the ability to rotate in satellite fashion and the rotation may be controlled by an orientation change mechanism such as a combination of a cam follower fixed to each carrier and a cam plate fixed to the non-rotating machine base.

In one aspect, a rotary indexing machine may include a main shaft configured to be driven in a rotary manner in a first direction, at least one carrier coupled to the main shaft and configured to rotate in the first direction and the at least one carrier configured to rotate independently in the first direction, a second direction, or both directions. The at least one carrier may be configured to hold at least one container. The rotary indexing machine may further include a stationary cam connected to a base, at least one carrier mounting arm attached to a respective at least one carrier, the at least one carrier mounting arm may be configured to be rotated by the main shaft in the first direction, and at least one cam follower may be configured on the at least one carrier arm and configured to contact the stationary cam causing the at least one carrier to rotate independently in the first direction, a second direction or either/both directions. The cam may be configured as a teardrop shape cam or a double teardrop shape cam. The at least one carrier may be configured to rotate independently in the first direction or the second direction while the main shaft indexes from a first indexing position to a second indexing position, wherein the at least one carrier moves at a reduced velocity. The at least one carrier may be a plurality carriers and each carrier may be configured to rotate independently in the first direction or the second direction while the main shaft indexes from a first indexing position to a second indexing position, wherein one of the carriers moves at a reduced velocity as compared with another carrier. Each carrier may be configured to rotate independently in the first direction or the second direction to change the orientation of at least one of the plurality of carriers as the main shaft indexes from one position to another position.

The main shaft may be configured to index from a first position to a second position and at least one of the plurality of carriers may be configured to rotate independently about its axis to change orientation from a first orientation at the first position to a second orientation at the second position. Moreover, the plurality of carriers may be configured to rotate independently so that each of the plurality of carriers changes orientation about its axis from a first orientation at the first position to a second orientation at the second position.

In one aspect, a rotary indexing machine includes a plurality of carriers configured to hold at least one container and configured to be indexed simultaneously by a common drive mechanism from a first position to a second position, and an orientation change mechanism configured to control the motion of the plurality of carriers so that the plurality of carriers operatively change orientation from the first position to the second position about an axis of each of the plurality of carriers, the orientation change mechanism, such as, e.g., a cam assembly, may be configured to cause a reduced velocity of the plurality of carriers from the first position to the second position. The axis may be separate from and substantially parallel to an axis of the common drive mechanism. The plurality of carriers may operatively change orientation from the first position to the second position by one of: about 45 degrees and about 22.5 degrees. The a plurality of carriers may be configured to be indexed simultaneously by the common drive mechanism from the first position to the second position in a first direction, and the plurality of carriers are configured to operatively change orientation about the axis in the first direction or the second direction based on the shaped of the cam. The reduced velocity may impart a reduced motion effect on the at least one container and any contents therein.

In one aspect, a rotary indexing machine may include a plurality of carriers configured to hold at least one container, each carrier configured with a separate vertical supporting member, a common drive mechanism configured to index the plurality of carriers from at least a first position to at least a second position and an orientation change mechanism configured to control the motion of the plurality of carriers in a satellite manner, so that the plurality of carriers operatively change orientation about a respective vertical supporting member from a first orientation at the first position to a second orientation at the second position, the orientation change mechanism configured to cause a reduced velocity on the plurality of carries from the first position to the second position.

### BRIEF DESCRIPTION OF THE DRAWINGS

The accompanying drawings, which are included to provide a further understanding of the invention, are incorporated in and constitute a part of this specification, illustrate embodiments of the invention and, together with the detailed description, serve to explain the principles of the invention. No attempt is made to show structural details of the invention in more detail than may be necessary for a fundamental understanding of the invention and the various ways in which it may be practiced. In the drawings:

FIG. 1 is an example of a rotary machine, according to the prior art;

FIG. 2A is an exemplary illustration of a rotary machine with reduced velocity index, configured according to principles of the invention;

FIGS. 2B and 2C are each a bottom view of FIG. 2A, more clearly showing an Advanced CAM Guide, configured according to principles of the invention;

FIGS. 2D and 2E are each a simplified perspective view of FIGS. 2B and 2C;

FIG. 2F is a side view of FIG. 2A, including a machine frame and main rotary base shaft;

FIGS. 2G-2H are exemplary top and bottom views respectively of an alternative CAM profile for a rotary machine, configured according to principles of the invention;

FIG. 3A is an exemplary illustration of a rotary machine with reduced velocity index with double output, configured according to principles of the invention;

FIGS. 3B and 3C are each a bottom view of FIG. 3A more clearly showing another Advanced CAM Guide, configured according to principles of the invention;

FIGS. 4A-4G are carrier assembly views, configured according to principles of the invention;

FIGS. 5A-5C are exploded views of a carrier assembly of FIGS. 4A-4G;

FIG. 6 is an isometric view of FIG. 2A; and

FIG. 7 is an illustration showing various steps of an operational process for using the rotary machine of FIG. 2A.

### DETAILED DESCRIPTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

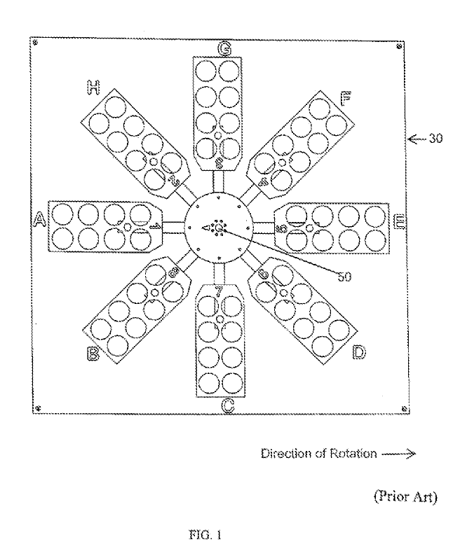

Referring to FIG. 1, a current state of the art rotary indexing machine 30 is shown where a set of carriers is fixed to a central rotating shaft (indexing table). The central shaft 50 may be driven clockwise or counterclockwise in indexing or continuous motion fashion. The set of carriers 1-8 is configured to be fixed to a central shaft 50 and therefore rotates with the shaft 50. Rotary machines may be used throughout various industries for different tasks. A product may be nested or held in the carriers and may be transferred from one position to the next through a process for preparing and/or sealing products. The carriers 1-8 may be configured to “carry” the products in a circular fashion.

If the product is of unstable shape or it is in fluid state, slower rotating (transferring) speed likely needs to be adopted (for all carriers 1-8) so the product remains in its location/container, and/or there is a reduction in motion-effect on the contents. An illustrative example may be a rotary filling and sealing machine widely used in the food industry. The various aspects of the invention will be described herein based on the rotary filling and sealing machine of this industry, but the principles are not limited to this field only.

Still referring to FIG. 1, a cup or number of cups (or other types of containers) (not shown) may be nested in the carriers 1-8. For example, eight empty cups may be dispensed at location “A” (the “cup dispensing station) into carrier #1. The rotary machine 30 shown in this example may turn (index) counterclockwise to move carrier #1 to the position marked as “B”.

The central shaft 50 of the machine 30 moves the rotary table in this case 45 degrees and with it all the carriers 1-8 rigidly attached to it. All eight carriers 1-8 travel the same distance (as measured at the outer edge of the carrier arc 19.234 inch, as an illustrative example) at a same speed. Location “B” may be a “filler station” where liquid product may be dispensed into empty cups (not shown) positioned below dispensing nozzles (not shown). Since with every index a liquid product (or other product) may be transferred—the indexing speed becomes one of the output limiting factors. In this example, the liquid may spill over the cup rim if the indexing speed is set up too high, therefore the cups cannot be filled too close to the rim if the rotary table cannot be slowed down.

The carriers 1-8 used on the state of the art rotary machine as shown in reference to FIG. 1 are connected to the main rotary base shaft 50 in a fixed fashion; therefore the carriers 1-8 are rotating with the Main Rotary Base Shaft 50, the same amount, at the same time and in the same direction.

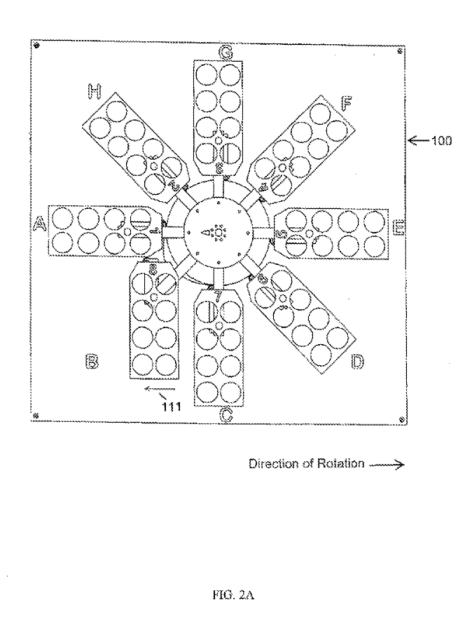

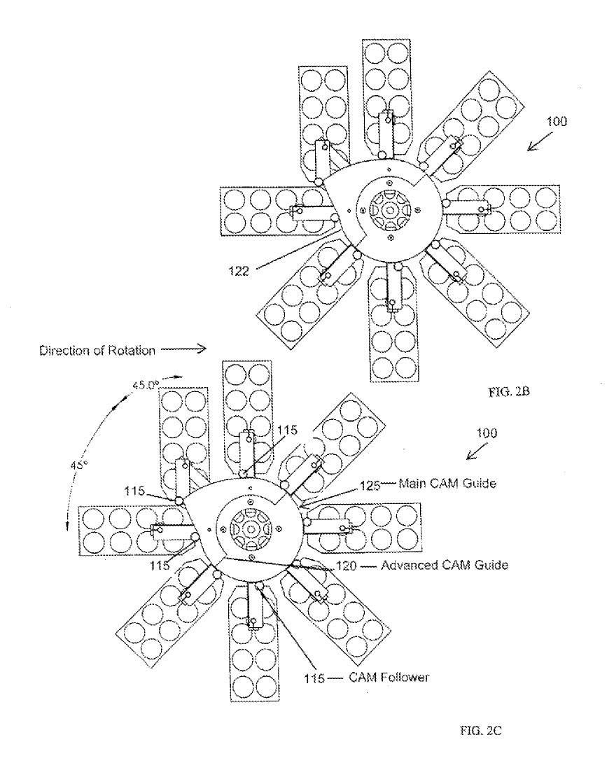

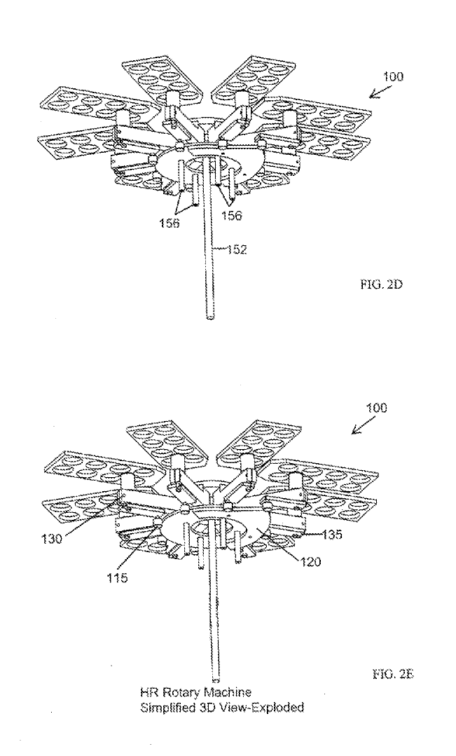

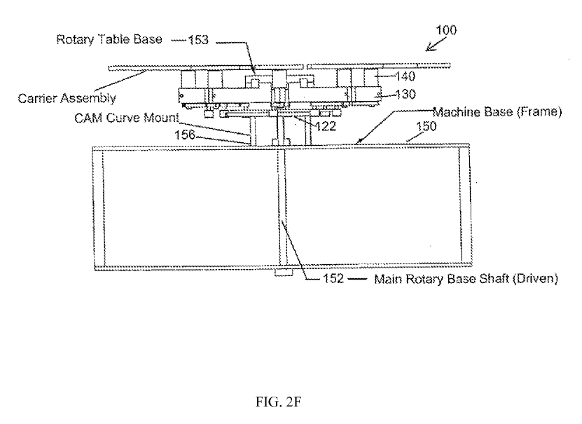

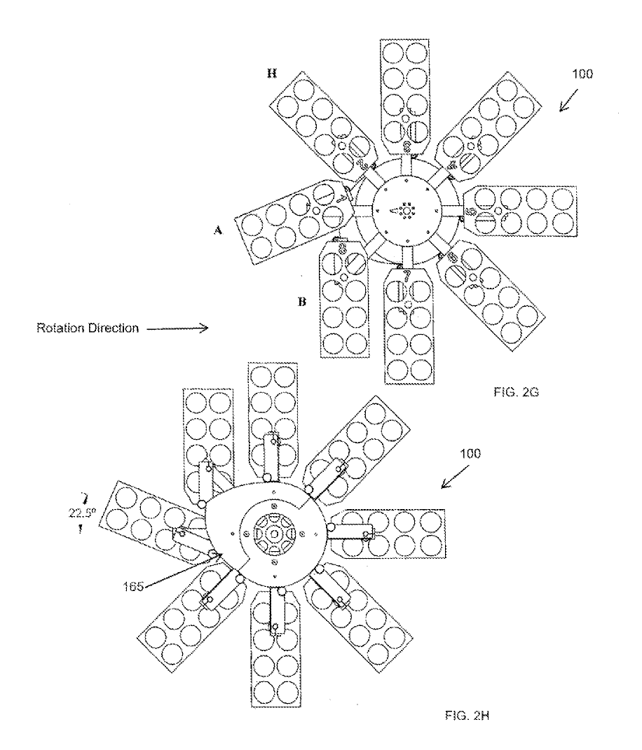

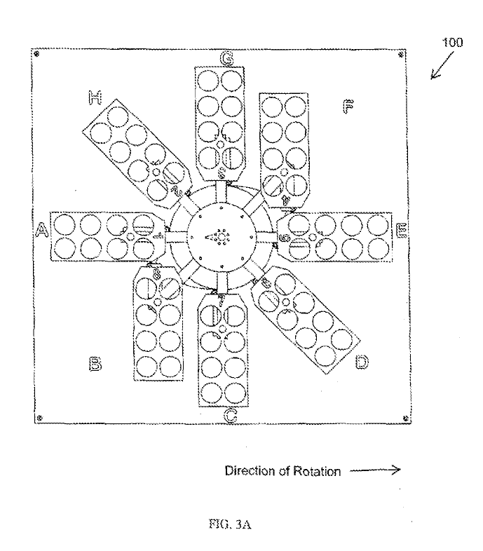

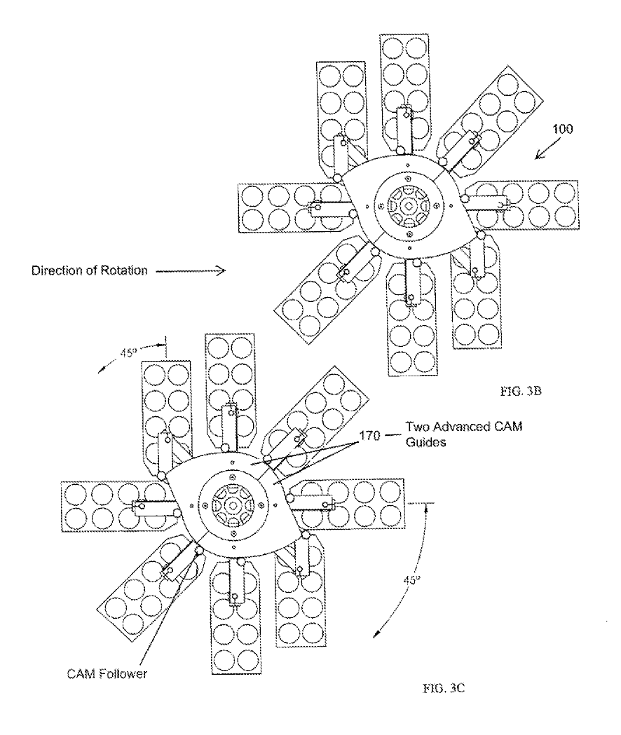

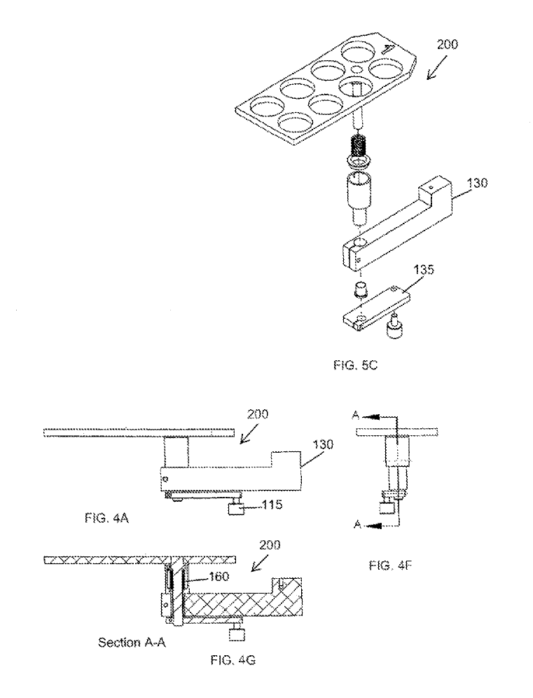

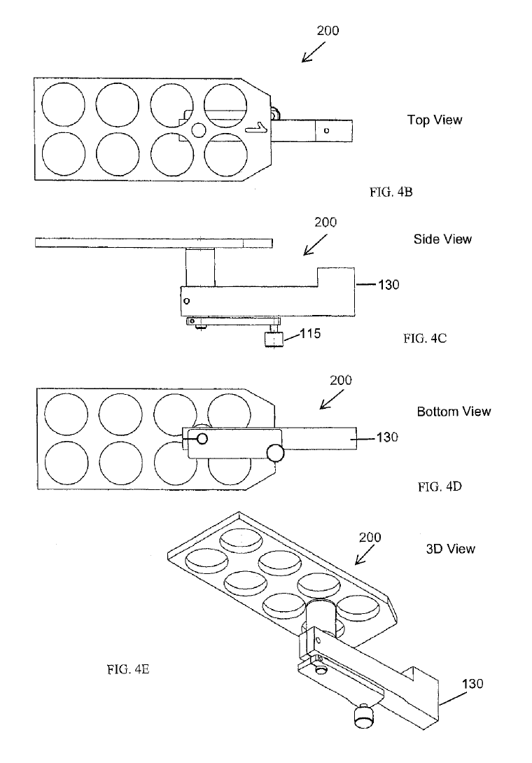

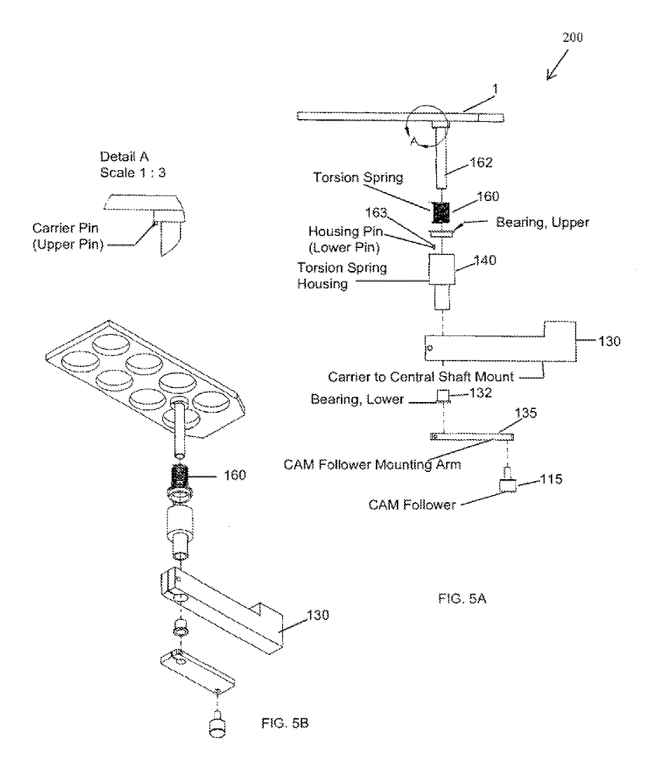

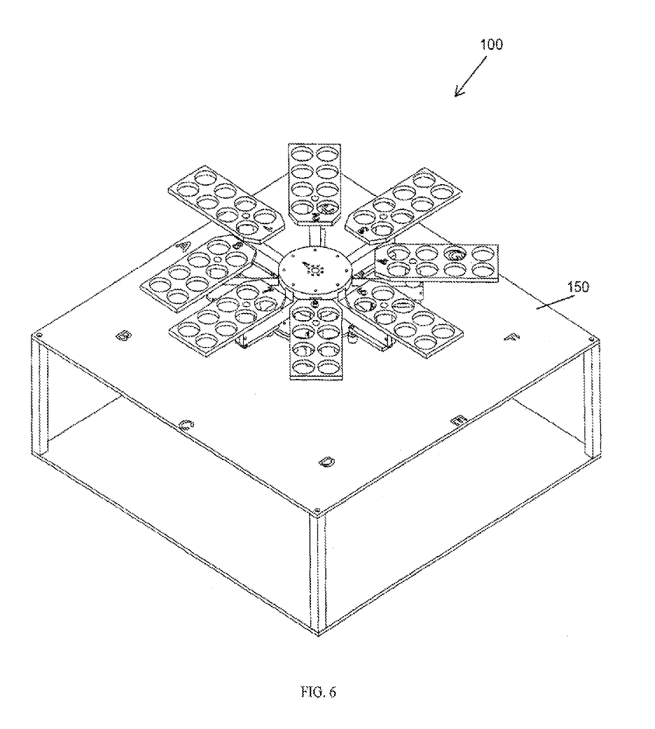

In contrast, and as explained more fully below, the carriers 1-8 configured on the rotary machine 100 that is capable of reduced velocity index, as configured according to principles of the invention herein (e.g., FIGS. 2A-3C), may be mounted to a carrier mounting arm 130 (see, FIGS. 2E, 5A) which acts as a mounting base for the carrier (shown in more detail in FIGS. 4A-4E, 5A and 5B). Part of each carrier 1-8 is coupled to a fixed shaft 162 (FIG. 5A) which enables each carrier 1-8 to rotate inside the mounting arm 130. The fixed shaft 162 may be configured substantially parallel to the vertical axis of the main rotary base shaft 152, but not necessarily limited to being parallel in every implementation. The main rotary based shaft 152 may be rotated by a power source (not shown) such as an electric motor.

On the opposite end of the fixed shaft 162 may be configured a fixed cam follower mounting arm 135 with cam follower 115. The cam follower 115 at the end of the cam follower mounting arm 135 has all the time contact with an orientation change mechanism such as a cam assembly 122 configured to change orientation of the carriers 1-8, in respect to each of their vertical axis. The cam assembly 122 may include cam guide(s) 120, 125, which forces the carriers 1-8 to rotate in a desired direction while the main rotary base shaft 152 moves. The shape of the cam guide(s) 120, 125, 165, 170 may determine the timing, the specific direction (i.e., clockwise or counterclockwise) and the amount (e.g., distance and/or speed) of the carriers' 1-8 rotation. The shape of the cam guides 120, 125, 165, 170 may be any applicable shape to produce desired direction or motion, such as the teardrop, or double teardrop shape.

Part of the carrier assembly 200 may include a preloaded torsion spring 160 and a one or a set of pins 163. The torsion spring 160 is configured to assure that the carriers 1-8 returns to its original position (where the carrier is aligned with the machine center) as soon as the cam (e.g., 120, 125, 165, 170) guiding it allows. The pin 163 may limit the amount of the carrier rotation.

FIGS. 2A-2H illustrate various views of a rotary machine with reduced velocity index, configured according to principles of the invention. The rotary system of FIGS. 2A-2H is configured with carriers 1-8 which are rotatable on their carrier mounting arm 130 independently from the main rotary base shaft 152 rotation. The carriers 1-8 may be configured to rotate independently in satellite fashion and the rotation may be configured to be controlled at least in part by a combination of a plurality of cam followers 115 fixed to each carrier 1-8 and a cam plate 122 fixed to the non-rotating machine base 150 (FIG. 2G) by supports 156. The aspects of invention illustrated in the FIGS. 2A-7 provide independently rotating carriers 1-8 that can rotate in a satellite mode in either a clockwise or counterclockwise direction (or both), in contrast to just fixed carriers as shown in FIG. 1. The independently rotating carriers 1-8 are configured to provide for a reduce velocity index.

Referring to FIGS. 2A-2H, the main rotary based shaft 152 of the rotary machine 100 may rotate 45 degrees and with it all the carrier assemblies 1-8. FIG. 2A is illustratively shown in a starting configuration with carrier #1 in position “A” and will be rotated counterclockwise into position “B,” while at the same time carrier #8 will be rotated into position “C”. That is, carrier #1 advances 45 degrees from the position “A” to “B”. Carrier #1 mounting arm 130 rotated 45 degrees (clockwise) as do the rest of the carriers 2-8 because it is rigidly mounted to the rotary table base 153 which is connected to the main rotary base shaft 152 that is rotated. However, carrier #1 itself will have swung an additional 45 degrees in the same clockwise direction (approx. arc distance 8.223″, for example) because the cam follower 115 was guided alongside the cam plate 122. The movement of carrier #1 was longer and more aggressive than the other seven carriers. Since the carrier #1 carries empty cups only, at this point, this does not pose any problem.

At the same time, carrier #8 will advance from position “B” to position “C” and its motion was also a combination of the main rotary base shaft 152 rotation and the carrier satellite motion. The satellite motion of carrier #8 was this time performed in the opposite direction (i.e., counter-clockwise, as denoted by arrow 111). This basically counteracted the main rotary base shaft 152 motion, at least in part. This configuration has an effect of reducing/negating/countering the overall impact of the motion imparted on the cups/containers and any contents therein. The carrier #8 profited from the “advanced” starting position at “B” as shown in the drawing. That is, a portion of the cups (not shown) in the carrier #8 having been filled with product while at position “B” benefited from the carrier #8 orientation at position “B”, and therefore needed to be moved over less distance (i.e., a shorter distance) while filled. Carrier #8 therefore may have had a much “smoother” transition than all the other carriers, such as being subject to less motion effects.

The position “C” is the cup or container closing position, i.e., “the sealing station” in this example. For example, a pre-die cut lid may be placed on top of the filled cups or a lidding material such as thin sealing film from a roll will be placed above the open container. The next step, still in the position “C,” the lidding material may be “heat-sealed” to the cup with sealing head and in case of a film also cut at the same time. This process is widely known in the industry as “lid pick & place and cup sealing” (in case of a pre-die cut lid) or “seal and cut in place” (in case of a film from a roll).

The next index of the carrier #1 from the sealing station to the next station (from the position “C” to the position “D”) happens without a need of combined motion. The product is already enclosed and cannot spill out; therefore a higher speed does not matter anymore. The “D” position is in this case “the out-feed station”.

In the example above, the complete cycle as described requires four stops (indexes) and may include:
1st cup de-nesting=position “A”
2nd cup filling position “B”
3rd cup sealing=position “C”
4th cup discharging position “D”

In the illustrations of FIG. 2A-2H, it is possible to provide for another, repeatable process on the remaining four positions (“E” thru “H”), which could be for example:
1st. cup de-nesting=position “E”
2nd. cup filling=position “F”
3rd. cup sealing=position “G”
4th. cup discharging=position “H”

FIGS. 3A-3C illustrate a reduced velocity index system with double output, configured according to principles of the invention. The rotary system of FIGS. 3A-3C is similar to the system illustrated in reference to FIGS. 2A-2H, except for the positions “E” through “H” may substantially replicate the stations “A”-“D” of FIG. 2A. This may be accomplished with integration of another set of cup dispenser, cup filler, sealing station and cup out-feed station (for example). A cam profile may be added to the applicable position.

One advantage of the rotary systems reduced velocity index system of FIGS. 2A-3C is that the machine speed could be turned higher and/or the cups/containers could be filled to a higher level, over current systems employed. This then may lead to higher production output. The rotary system of FIGS. 2A-2H has been demonstrated to provide substantially increased output over and above that of the state of the art shown in relation to FIG. 1. Likewise, the output of the two cam system of FIGS. 3A-3C has been shown to be essentially double that of the one cam system shown in relation to FIGS. 2A-2H.

FIG. 2C shows a first type of advanced cam guide, constructed according to principles of the invention. FIGS. 3B and 3C show a second type of an advanced cam guide, configured according to principles of the invention. The cam curve (the contour shape of the cam) depicted in FIGS. 3B and 3C is configured for 90 degrees of motion (over two indexes).

FIGS. 2G and 2H illustrate a third type of advanced cam guide 165, constructed according to principles of the invention. The advanced cam guide 165 of FIG. 2H shows a cam curve designed for “less aggressive swing” of a carrier (as compared with the advanced cam guide of FIGS. 2C, 3B and 3C). In FIG. 2G, carrier #1 is shown in an advanced state in its “cup de-nesting position,” i.e., position “A “. The carrier #1 started its “cam forced move” already from the position “H” in order to ease the “swing” motion from “A” to “B.” In another words, the 45 degrees rotation of the carrier #1 around its own axis (such as described in relation to FIG. 2C), was split in, e.g., two 22.5 degrees swings, as shown in relation to FIG. 2G, the first 22.5 degrees of rotation started at position “H” and the second 22.5 degrees of rotation performed from position “A” to position “B”. (Other ranges of degrees may be employed in other applications).

One additional variation (not shown) of the above described concepts may include a configuration that also has a following index—motion from position “C” to the next position referred to as position “0” could happen at the “reduced” speed utilizing the combined carrier rotation. The carrier may be turned with a differently shaped cam while the machine rotates another 45 degrees from the position “C” to the position “0”. This time the carrier stays “behind”. In another words the cam curve will force the cam follower attached to the carrier in the 45 degrees in the opposite direction. The move after that (from “D” to “E”) would have to “straighten” the carrier #1 again. The motion of the carrier from position “C” to position “D” would be a “mirrored motion” of a carrier from position “B” to position “C.”

FIGS. 4A-4G are various carrier assembly 200 views. FIG. 4A is a side view; FIG. 4B a top view; FIG. 4C a side view; FIG. 4D is a bottom view; FIG. 4E a perspective view; FIG. 4F is an end on view; and FIG. 4G is a sectional view taken along lines A-A of FIG. 4F. These components are described in more detail in relation to FIGS. 5A-5C.

FIGS. 5A-5C are exploded views of the carrier assembly 200 of FIGS. 4A-4G. The carrier assembly 200 may comprise carrier 1 (and similarly reflect other carriers 2-8) which may include a fixed shaft 162 (which may be a vertical mounting post) mounted on a lower surface, a torsion spring housing 140 to hold a torsion spring 160 in place around the fixed shaft 162, a upper bearing and a lower bearing 132, a housing pin 163 (which may be a set of pins) to hold the torsion spring 160 and torsion spring housing 140 in place, a mounting arm 130 which may act as a carrier to central shaft mount (i.e., to the rotary base shaft), a cam follower mounting arm 135 and a cam follower 115. The torsion spring 160 applies pressure to assure that the carrier assembly orients itself as the assembly 200 via the cam follower 115 follows the shape of a cam such as cams 120, 125, 165, 170. The carrier 1 and fixed shaft 162 may rotate within the mounting arm 130 and cam follower mounting arm 135.

FIG. 6 is an isometric view of FIG. 2A.

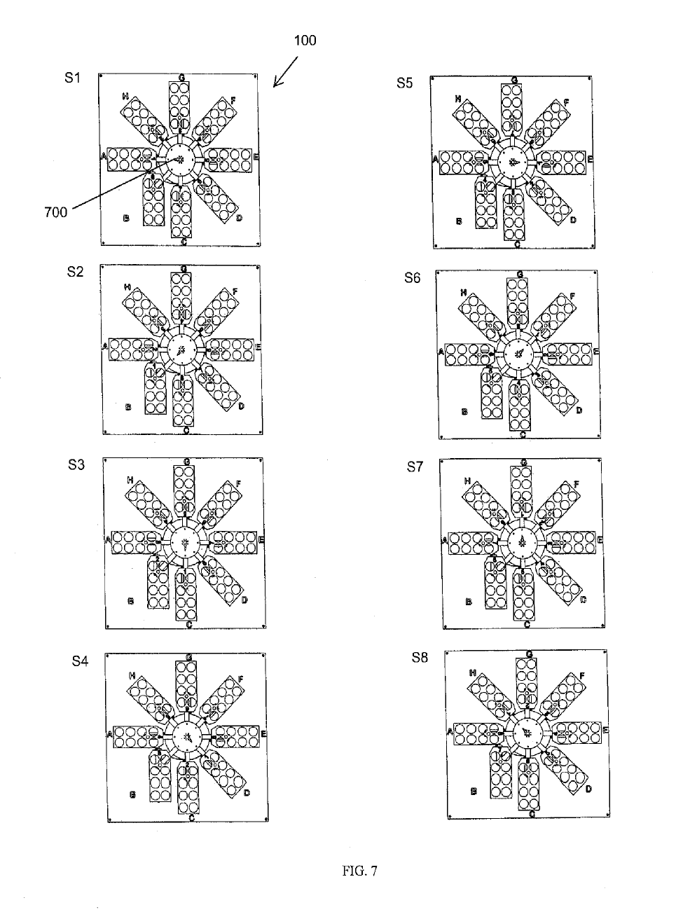

FIG. 7 is an illustration showing various steps of an operational process for using the rotary machine of FIG. 2A. The illustrative eight positional sequences (or steps) can be followed by viewing the “pointer” 700 located in the center of the rotary machine 100 from sequence to sequence, which moves from the nine o'clock position in sequence S1 to the eight o'clock position in sequence S2, to the six o'clock position in sequence S3, and so forth, to sequence numbered S8 where the “pointer” is shown at the eleven o'clock position.

The various aspects disclosed herein provide for one or more carriers that may be rotated on their mounting base independently from the main shaft rotation. The individual carriers have the ability to rotate in satellite fashion (and at a different relative rotation speed, at least temporarily, compared with the main shaft rotation speed) and may be controlled by a cam follower affixed to or coupled with each carrier and a cam plate fixed to or couple to the non-rotating machine base. The “cam follower” aspect herein may be accomplished in different manners. Moreover, in different implementations, the rotational directions shown herein may be implemented in opposite directions while still adhering to principles of the invention.

The various aspects herein provide for a rotary machine with reduced velocity index that can be varied in speed so that the effects on contents being packaged is reduced from a first station to a second station. The contents may be a liquid, a solid, or a combination of the two. The reduction may be accomplished while the main speed of the central carrier assembly such as a drive shaft moves at a first speed, while relative speed of motion for one or more of the carriers attached to the central carrier assembly such as a drive shaft is altered by a cam assembly that reduces the effect of moving the one or more carriers from a first position to a second position thereby the contents (which many be a liquid) being carried in the one or more carriers has an effective reduction in rotational speed of motion, and may prevent accidental spillage at this stage. This has an overall effect of speeding up total production of a packing process, since the first speed may be higher than normally used compared to existing systems before this disclosure. Moreover, the net effective motion effect of a carrier moving from a first station to a second stage may be different from the net effective motion effect of a carrier moving from a third station to a fourth station (and all carriers in motion simultaneously).

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A rotary indexing machine, comprising:
a main shaft configured to be driven in a rotary manner in a first direction;
at least one carrier coupled to the main shaft and configured to rotate in the first direction and the at least one carrier configured to rotate independently in the first direction, a second direction, or both directions.

2. The rotary indexing machine of claim 1, wherein the at least one carrier is configured to hold at least one container.

3. The rotary indexing machine of claim 1, further comprising:
a stationary cam connected to a base;
at least one carrier mounting arm attached to a respective at least one carrier, the at least one carrier mounting arm configured to be rotated by the main shaft in the first direction; and
at least one cam follower configured on the at least one carrier arm and configured to contact the stationary cam causing the at least one carrier to rotate independently in the first direction, a second direction or either direction.

4. The rotary indexing machine of claim 3, wherein the cam comprises a teardrop shape cam or a double teardrop shape cam.

5. The rotary indexing machine of claim 1, wherein the at least one carrier is configured to rotate independently in the first direction or the second direction while the main shaft indexes from a first indexing position to a second indexing position, wherein the at least one carrier moves at a reduced velocity.

6. The rotary indexing machine of claim 1, wherein the at least one carrier is a plurality carriers and each carrier is configured to rotate independently in the first direction or the second direction while the main shaft indexes from a first indexing position to a second indexing position, wherein one of the carriers moves at a reduced velocity as compared with another carrier.

7. The rotary indexing machine of claim 1, wherein the at least one carrier is a plurality carriers, and each carrier is configured to rotate independently in the first direction or the second direction to change the orientation of at least one of the plurality of carriers as the main shaft indexes from one position to another position.

8. The rotary indexing machine of claim 7, wherein the main shaft is configured to index from a first position to a second position and at least one of the plurality of carriers is configured to rotate independently about its axis to change orientation from a first orientation at the first position to a second orientation at the second position.

9. The rotary indexing machine of claim 7, wherein the plurality of carriers are configured to rotate independently so that each of the plurality of carriers changes orientation about its axis from a first orientation at the first position to a second orientation at the second position.

10. A rotary indexing machine, comprising:
a plurality of carriers configured to hold at least one container and configured to be indexed simultaneously by a common drive mechanism from a first position to a second position; and
a orientation change mechanism configured to control the motion of the plurality of carriers so that the plurality of carriers operatively change orientation from the first position to the second position about an axis of each of the plurality of carriers, the orientation change mechanism configured to cause a reduced velocity of the plurality of carriers from the first position to the second position.

11. A rotary indexing machine of claim 10, wherein the axis is separate from and substantially parallel to an axis of the common drive mechanism.

12. A rotary indexing machine of claim 10, wherein the plurality of carriers operatively change orientation from the first position to the second position by one of: about 45 degrees and about 22.5 degrees.

13. A rotary indexing machine of claim 10, wherein the a plurality of carriers are configured to be indexed simultaneously by the common drive mechanism from the first position to the second position in a first direction, and the plurality of carriers are configured to operatively change orientation about the axis in the first direction or the second direction based on the shaped of the cam.

14. A rotary indexing machine of claim 13, wherein the first direction is counterclockwise and the second direction is clockwise.

15. A rotary indexing machine of claim 13, wherein the first direction is clockwise and the second direction is counterclockwise.

16. A rotary indexing machine of claim 10, wherein the reduced velocity imparts a reduced motion effect on the at least one container and any contents therein.

17. A rotary indexing machine of claim 10, wherein the orientation change mechanism comprises a cam assembly.

18. A rotary indexing machine, comprising:
a plurality of carriers configured to hold at least one container, each carrier configured with a separate vertical supporting member;
a common drive mechanism configured to index the plurality of carriers from at least a first position to at least a second position; and
an orientation change mechanism configured to control the motion of the plurality of carriers in a satellite manner, so that the plurality of carriers operatively change orientation about a respective vertical supporting member from a first orientation at the first position to a second orientation at the second position, the orientation change mechanism configured to cause a reduced velocity on the plurality of carries from the first position to the second position.

19. A rotary indexing machine of claim 18, wherein the reduced velocity imparts a reduced motion effect on the at least one container and any contents therein.

20. A rotary indexing machine of claim 18, wherein the orientation change mechanism comprises a cam assembly.
